(19) United States
(12) Patent Application Publication
(10) Pub. No.: US 2015/0121252 A1
(43) Pub. Date: Apr. 30, 2015

(54) Combined Data Streams for Group Calls

(71) Applicant: GFACE GMBH, Frankfurt/Main (FR)

(72) Inventor: Cevat Yerli, Frankfurt/Main (DE)

(21) Appl. No.: 14/365,098

(22) PCT Filed: Dec. 28, 2012
(86) PCT No.: PCT/EP2012/005394

§ 371 Date: Jun. 12, 2014

Related U.S. Application Data
(60) Provisional application No. 61/581,227, filed on Dec. 29, 2011.

(51) Int. Cl. H04L 29/06; G06F 3/0484; H04L 29/08

(52) U.S. Cl. CPC H04L 65/403; H04L 65/60; H04L 67/10; G06F 3/0484
USPC 715/753; 709/204

(57) ABSTRACT

A communication system enabling group calls comprises a communication network, a plurality of communication devices connected to the communication network, wherein each communication device is responsive to at least one user and includes means for providing a data stream, and a processing component connected to the communication network, configured to receive the data streams from at least some of the plurality of communication devices via the communication network, and to generate from the data streams a combined data stream. The processing component is further configured to provide the combined data stream to at least one of the plurality of communication devices. Furthermore, a communication device and a method for enabling group calls are provided.

### TECHNICAL FIELD

The present disclosure relates to a communication system enabling group calls, a communication device providing access to group calls, and, in particular, to a method for enabling group calls. Moreover, the disclosure may relate to group calls based on combined data streams, such as media or multimedia streams.

### BACKGROUND

Group calls are generally known in telecommunications as a technique for joint communication between a calling party and more than one called party. For example, in a conference call, the calling party may enable the called parties to listen to the audio portion of the call. Generally, a calling party successively calls desired participants and adds them to the group call if they answer the call. Therefore, setting up a group call may be complicated if participants cannot be directly reached. Also, since each participant has to be called individually, the time for setting up a group call increases with the number of desired participants.

Furthermore, multipoint video telephony or video conferencing approaches are known, wherein participants exchange audio/video data. Typically, the audio/video data of each participant is replicated and provided to the other participants of the video conference. Each participant receives a number of different audio/video data from different participants. Accordingly, the amount of data may increase with the number of participants of the video conference. Furthermore, conflicts may arise if the format of the different audio/video data cannot be presented on the hardware of the participant.

Thus, there is a need in the art for improvements of group calls. In view of the above, one object is to ameliorate setup and realization of group calls. In particular, one object is to reduce the data traffic produced by a group call and to provide a more hardware-independent group call technology.

### SUMMARY

The problem is solved by the communication system, and the method for enabling group calls as defined in the independent claims. Furthermore, a communication device providing access to group calls is defined. Preferred embodiments are defined in the corresponding dependent claims.

A first aspect of the present disclosure provides a communication system enabling group calls, comprising a communication network, a plurality of communication devices connected to the communication network, each communication device being responsive to at least one user and including means for providing a data stream, and a processing component connected to the communication network, configured to receive the data streams from at least some of the plurality of communication devices via the communication network, and to generate from the data streams a combined data stream. Furthermore, the processing component is configured to provide the combined data stream to at least one of the plurality of communication devices.

The communication devices may stream the data streams to the communication network, where it may be routed or otherwise provided to the processing component of the communication network. Initially, at least some of the communication devices may interact with the communication network according to a communication protocol in order to retrieve an address or identification of the processing component, which will be responsible for and serve the respective communication devices. Thereafter, the communication devices may address the data streams to the processing component. In addition, the data streams may include an indication of a group call or a group call session enabling the processing component of the communication network to identify participants of the group call and/or their communication devices. The system may also include a plurality of processing components, wherein each processing component may be associated with a group call. Accordingly, the address or identification of the processing component may directly identify the associated group call.

The processing component or any further processing component may be implemented as a hardware module, a software module executed on at least one server, or a combination of software and dedicated hardware, connected to the communication network. Accordingly, a processing component may be allocated on the fly for each new group call hosted by the communication system. Also, the communication system may provide a predetermined number of processing components, each serving one or more group calls.

In order to generate the combined data stream, the processing component may store or buffer the received data streams, decode each respective data stream according to one or more codecs or encoding/decoding formats, process the decoded data stream, and combine the processed decoded data streams into a raw combined data stream. The raw combined data stream may be further encoded based on available bandwidth, desired format and quality, and other parameters affecting encoding of data streams. The final encoded raw combined data stream may represent the combined data stream which is provided to at least one communication device or two or more communication devices participating in the group call. Hence, the content of the combined data stream provided to each participating communication device may be essentially the same.

The format of the combined data stream may be the same for each receiving communication device. However, the processing component may also be configured to encode the combined data stream according to different formats or codecs for the individual receiving communication devices. For example, the processing component may initially negotiate the format of the received data stream and the format of the provided combined data stream with each new communication device connected to the processing component. Thereafter, the processing component may configure the decoding of the data stream and encoding of the combined data stream according to the negotiated parameters.

The communication system allows for a flexible, dynamic, and improved processing of group calls. By providing a combined data stream to designated communication devices instead of a plurality of data streams from individual communication devices, the data traffic on the communication network is greatly reduced. Furthermore, since any decoding of individual data streams and encoding of the combined data stream is performed by the processing component, the communication devices need not support a broad variety of data stream formats and codecs. Instead, each communication device may provide the data stream according to a local format, which is recognized by the processing component, and may be only capable of supporting the format of the resulting combined data stream, which may also correspond to the local format of the communication device or another format understood by the communication device.

Group calls using the communication system may also be easily set up, since communication devices may be dynamically added to the group call without affecting the processing related to the previous participants. Rather, the communication device of the new participant may initiate the data stream, which may thereafter be included into the combined data stream for the participants of the group call, and may start receiving the combined data stream.

In one embodiment, the processing component is further configured to provide the combined data stream to at least one of the communication devices providing the data streams for the combined data stream. Accordingly, at least one or each communication device, which provides a data stream to the processing component, may be configured to receive and display the combined data stream. At least one communication device, or two or more communication devices associated with a group call providing respective data streams, may display the received combined data stream to the local user.

According to another embodiment, at least some of the communication devices further include means for recording the data stream, wherein the data stream is related to the respective at least one user of the communication device. For example, the means for recording may be a video camera, a microphone, and/or any other recording device or sensor which may be attached to or integrated within the communication device.

In yet another embodiment, the processing component is further configured to receive a request from at least one of the plurality of communication devices and to provide the combined data stream to the at least one communication device in response to the request. In addition, the processing component may check access restrictions and permissions related to the communication device and/or the respective user requesting the combined data stream.

In a further embodiment, at least some of the plurality of communication devices form a group of communication devices associated with a group call, and the processing component is configured to receive data streams from at least some of the group of communication devices, and to provide the combined data stream to at least one of the group of communication devices. The processing device may also be configured to directly receive the data streams from every communication device of the group, and/or to provide the combined data stream to every communication device of the group. Hence, initially each participant of the group call may be involved in the group call and may, subsequently, restrict the group call to reception of the combined data stream only, thereby representing an anonymous participant of the group call. Each participant may also restrict the group call to providing of the local data stream only, for example, in order to mute or pause the presentation of the combined data stream on the communication device.

In one embodiment, the processing component is further configured to provide to each communication device of the group a graphical user interface including one or more items representing at least some of the users of the communication devices of the group, wherein each item includes an indication of participation of the respective user in the group call. Accordingly, the users may directly observe who is participating or who intends to participate in the group call.

According to an embodiment, each graphical user interface includes one or more interactive elements, which enable the respective user to control the group call. Preferably, the one or more interactive elements further enable the user to control participation of the user in the group call by accepting or declining a call request. The processing component may be set up to directly reflect any changes in the participation in the respective user interfaces. Hence, any change in participation in every stage of the group call, such as during initialization of the group call, or later on during active communication, may be directly synchronized via the processing component at each user interface on the communication device.

In another embodiment, the one or more interactive elements further enable the user to control providing of the data stream from the communication device of the user to the processing component via the communication network. In yet another embodiment, the one or more interactive elements further enable the user to control receiving of the combined data stream from the processing component via the communication network. Hence, the graphical user interface may be used to simplify control of the group call.

In a further embodiment, the processing component generates the combined data stream according to at least one stream build list provided by a service. The stream build list may define a list of logical media or data items included in the data stream.

According to an embodiment, the processing component generates the combined data stream according to a predefined quality independently from any characteristics of the communication devices. The communication system may, for example, predefine a certain format, resolution, and frame rate of the combined data stream. Each communication device trying to request the combined data stream may be checked for compliance with the predefined format.

In another embodiment, at least one of the communication devices interacts with the processing component to modify the quality of the combined data stream. Preferably, the processing component provides the modified combined data stream to other communication devices only if the other communication devices interact with the processing component to indicate the same choice of modification.

In one embodiment, the processing component is further configured to provide to a user initiating the group call a personalized interface with further interactive elements that enable the user to set up the group call. The user initiating the group call may, for example, select a group of other users. The communication system or the processing component may thereafter identify the communication devices of the group and may invite the users to join the group call. The initiating user may also start and/or terminate the group call, and may also control the participation of active participants of the group call.

According to an embodiment, the data streams are video streams and the combined data stream is a combined video stream. Each communication device may include a video camera recording the respective video stream sent to the processing component via the communication network, and may further include a display to represent the combined video stream. The combined video stream may include frames, wherein each frame may include frames of the video streams of the other participants in a reduced size, which may be arranged according to a predefined pattern, such as side by side, tiled, or stacked, and combinations thereof.

In one embodiment, the communication network is one of a mobile network, a telephone network, and an IP-based network.

In yet another embodiment, the processing component is implemented as a computing cloud, including a rendering cloud. Preferably, the computing cloud receives data streams from a plurality of data sources of the communication devices and generates from the data the combined data stream.

In another embodiment, the communication network provides access to a social network, and at least some of the communication devices or at least some users are registered at the social network. Furthermore, the communication network may be directly linked with the social network, such that any access to the communication network may be directly provided to respective processing components of the social network.

Furthermore, a communication device providing access to group calls according to the present disclosure is provided, comprising means for providing a data stream to a communication network, and means for receiving a combined data stream to output the combined data stream to the at least one user, wherein a processing component of the communication network receives the data stream and at least one further data stream from at least one further communication device via the communication network, and generates from the data stream and the at least one further data stream the combined data stream.

In one embodiment, the communication device further comprises means for displaying a graphical user interface provided by the processing component, including one or more items representing at least some of the users of the further communication devices, wherein each item includes an indication of participation of the respective user in the group call.

According to another embodiment, the communication device is one of a mobile device, a telephone device, a terminal device, and a computing device. Mobile devices may include any kind of portable communication device, such as a mobile phone, a smartphone, a PDA, a laptop, a tablet PC, and any other computing device including a wireless communication interface enabling the device to connect to the communication network, as well as respective means for providing the data stream to the processing component via the communication network.

It is to be understood that the communication device according to embodiments of the present disclosure may communicate and/or be coupled to any communication network according to embodiments of the present disclosure to enable participation in group calls.

Furthermore, a computer-implemented method for enabling group calls according to the present disclosure comprises the steps of receiving data streams from at least some of a plurality of communication devices via a communication network, generating from the data streams a combined data stream, and providing the combined data stream to at least one of the plurality of communication devices.

In one embodiment, the method further comprises receiving a request from at least one of the plurality of communication devices and providing the combined data stream to the at least one communication device in response to the request.

In another embodiment, at least some of the plurality of communication devices form a group of communication devices associated with a group call, wherein said receiving includes receiving data streams from at least some of the group of communication devices, and said providing includes providing the combined data stream to at least one of the group of communication devices.

According to yet another embodiment, the method further comprises providing to each communication device of the group a graphical user interface including one or more items representing at least some of the users of the communication devices of the group, wherein each item includes an indication of participation of the respective user in the group call.

In one embodiment, said generating includes generating the combined data stream according to at least one stream build list provided by a service.

Furthermore, the communication system and the communication device according to embodiments of the present disclosure may include data structures, components, or modules which may be configured to perform any of the processing steps of a method according to an embodiment of the present disclosure in any combination.

In addition, a computer-readable medium according to the present disclosure has instructions stored thereon, wherein said instructions, in response to execution by a computing device, cause said computing device to automatically perform a method according to embodiments of the present disclosure. The computer-readable medium may be accessible by the computing device, for example, a processing component of a communication system according to one embodiment of the present disclosure, which may access the computer-readable medium and read the instructions thereon. The instructions may be stored in a memory of the computing device and may configure the computing device to perform respective processing steps of the method. Preferably, the computing device may be configured to automatically receive data streams from at least some of a plurality of communication devices via a communication network, generate from the data streams a combined data stream, and provide the combined data stream to at least one of the plurality of communication devices. However, it is to be understood that the computing device may further be configured to perform any further processing according to embodiments of the present disclosure.

According to another aspect, there is provided a network-based system of providing a combined single data stream to at least one user device or user group device, the system comprising a computing cloud receiving different data from a plurality of data sources and generating from said data a single data stream to be provided to at least one remote user or user group, and equipment, such as at least one user device or user group device having access to the computing cloud for receiving said combined single data stream to be outputted for the at least one remote user or user group.

According to yet another aspect, a method of providing a combined single data stream to at least one user device or user group device within a network-based system is provided, the method comprising the steps of receiving at a computing cloud different data from a plurality of data sources, generating from said data a single data stream to be provided to at least one remote user or user group, and receiving at the at least one user device or user group device, said combined single data stream to be outputted for the at least one remote user or user group.

In one embodiment, the described systems and methods may use a render cloud to compute the stream online, before the rendered data is transferred to the client's device. This way, the quality of the content may always be at a premium level, or any quality level desired by the content provider. The structure of the cloud may provide a constant high level of performance through the distributed nature of the one or more cloud servers.

According to another embodiment, the content can be multimedia content, such as audio, 2D or 3D video, still pictures, animations, and others. The content can also be interactive in its presentation. For example, the content may include advertisements or interactive advertisements. Thus, the different data may comprise media data, in particular video, audio, still images and/or graphics, from said plurality of data sources, and wherein the computing cloud renders said different data for generating said single data stream to be provided to the at least one remote user.

In one embodiment, the plurality of data sources may comprise media data servers and/or sources, in particular game servers and/or ad servers. Also, the computing cloud may comprise a plurality of cloud servers, in particular media Tenderers, performing the data computations, in particular the rendering of media data, to provide said single data stream. The plurality of cloud servers may perform said data computations according to at least one stream build list provided by a service and/or by said data sources. Moreover, the plurality of cloud servers may perform said data computations for a predefined quality of service independently from any condition and/or characteristic of the user device's display.

The term “stream build list” may define a list of logical media or other items that are comprising the stream. The list may also contain additional meta data that defines where the logical media items are placed in the stream, in terms of time and space. The list can be formatted as an XML file listing all elements with their parameters. This list may be a structure that is used by the system to generate one stream from the single files.

In one embodiment, the plurality of cloud servers generate said single data stream to be provided to a plurality of user devices. In another embodiment, the plurality of cloud servers generate individually for a plurality of users or groups of users several single data streams to be provided individually to the users and/or groups of users.

In a further embodiment, the at least one user device may comprise at least one client computer or terminal being connected via a network, in particular an IP network, to said plurality of cloud servers. Preferably, the at least one user device interacts with said plurality of cloud servers to modify the provided single data stream. The plurality of cloud servers may provide said modified single data stream to several user devices only if said user devices interact with said plurality of cloud servers to indicate the same choice of modification.

According to one embodiment, the described method of providing said combined single data stream may further comprise at least one of requesting a computation, in particular a rendering, of said different data for generating said single data stream, generating said single data stream according to a stream build list provided by a service and/or by said data sources, transmitting via a network, in particular an IP network, said single data stream to the at least one user device, which in particular is a client device, and displaying the data stream at the at least one user device, which in particular is a client device.

### DESCRIPTION OF THE DRAWINGS

The specific features, aspects, and advantages of the present disclosure will be better understood with regard to the following description and accompanying drawings where:

FIG. 1 shows a graphical user interface provided on a communication device by a group call communication system according to one embodiment of the present disclosure;

FIGS. 2A and 2B show graphical user interfaces provided on communication devices according to embodiments of the present disclosure;

FIG. 3 depicts a structure of a network-based system according to one embodiment of the present disclosure;

FIG. 4 illustrates functional and structural components of a communication system according to one embodiment of the present disclosure;

FIG. 5 illustrates functional and structural components of a communication system according to one embodiment of the present disclosure; and

FIG. 6 shows a flow chart of a method for enabling group calls according to one embodiment of the present disclosure.

### DETAILED DESCRIPTION

In the following description, reference is made to drawings which show by way of illustration various embodiments. Also, various embodiments will be described below by referring to several examples and use cases. It is to be understood that the embodiments may include changes in design and structure without departing from the scope of the claimed subject matter.

According to an example, a group call system according to an embodiment of the present invention may be implemented as a part of a social network or computing cloud. Accordingly, two or more data streams, such as audio/video streams, can be mixed and combined into a single data stream using cloud-based rendering, as will be described in greater detail below. However, embodiments of the present disclosure can also be implemented without a social network or a computing cloud on traditional communication networks, such as mobile communications networks.

According to embodiments of the present disclosure, users may activate a cloud-based or network-based group call with a constant quality of the rendered content, which may be independent of the computing power of a client device of the user, such as a personal computer, a mobile phone, a smartphone, a laptop, a tablet PC, a TV set, a game console, or the like. In particular, callers may also interact with the group call system and control the group call in a much deeper and more comprehensive way than is possible in typical voice calls. Callers may be able to see who is picking up and then set different types of connections to the group or groups of users. In particular, a caller may directly retrieve information about who has picked up a call, who is yet to pick up the call, and who has declined a call. Furthermore, a constant quality of all streamed content may be achieved through direct control of the group call system and the quality of the streamed content may be entirely independent of the computing power of the user or client devices.

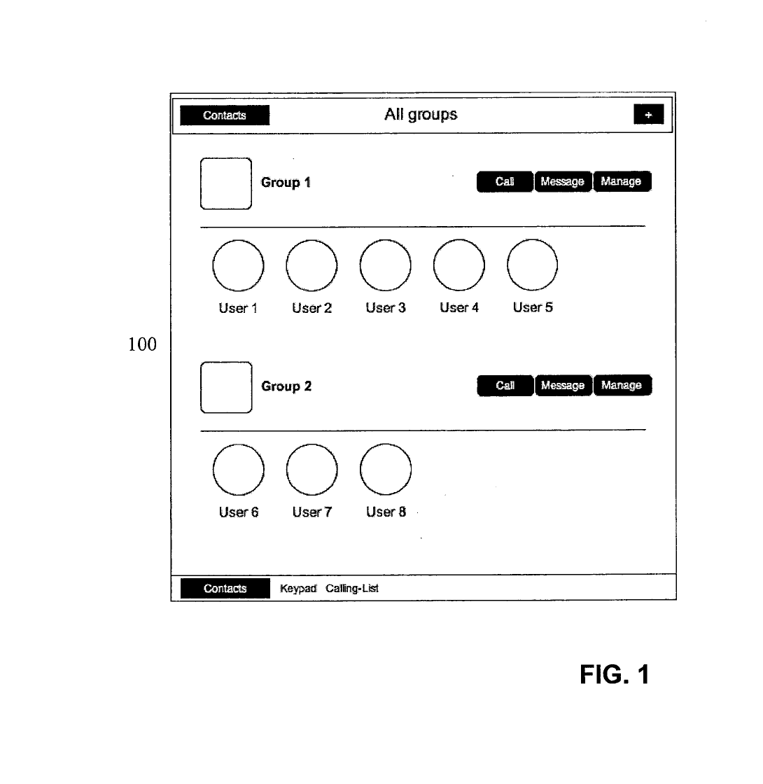

FIG. 1 shows a graphical user interface provided on a communication device by a group call communication system according to one embodiment of the present disclosure. The graphical user interface 100 may be configured as a start screen and presented to a user (caller) at a communication device or respective user device. The graphical user interface 100 may, for example, enable the user to initiate a group call. The start screen of the graphical user interface 100 may be represented as a phone book that enables the user to navigate through groups of other users, manage groups of users, and also to interact in a deeper level with settings of one of the groups.

The start screen of the graphical user interface 100 may show items for all users or members of a group. The graphical user interface 100 may provide the caller with various options, such as to call, message, or manage (administer) a group or a plurality of groups, for example, “Group 1” including “User 1” to “User 5,” and “Group 2” including “User 6” to “User 8,” wherein the various members of a group are shown as respective users. The various groups may be represented on the start screen of the graphical user interface 100 as icons or similar elements on the graphical user interface 100. The options may be activated via interactive elements of the graphical user interface 100, such as interactive elements labeled as “Call,” “Message,” or “Manage.”

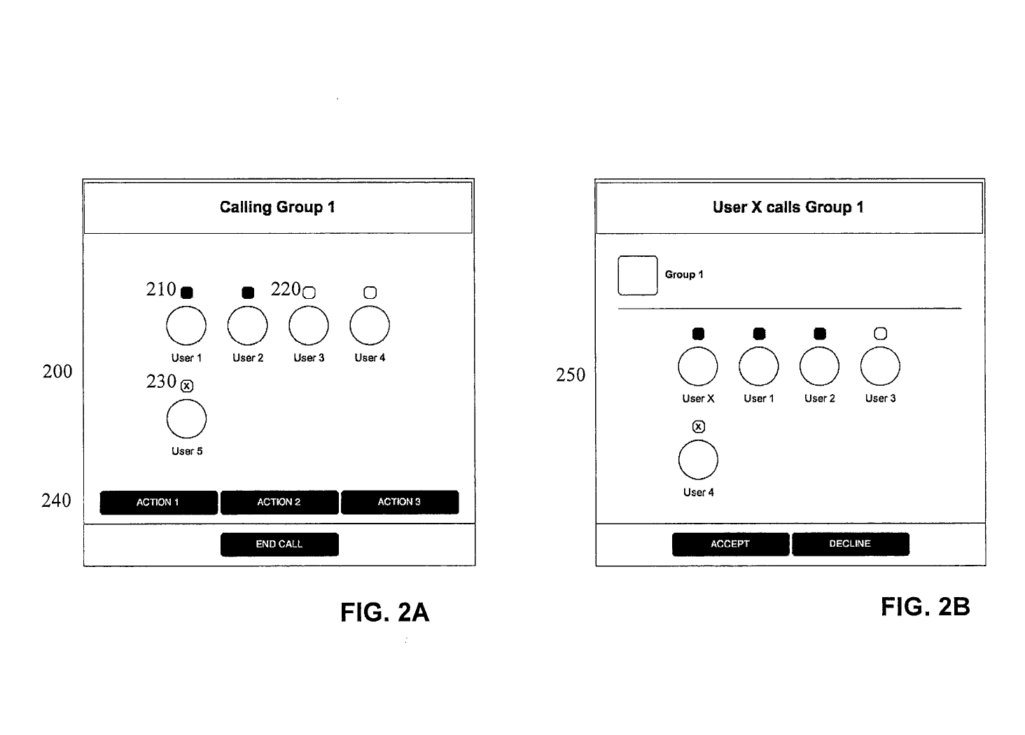

To initiate some form of communication with members of the group, the caller may choose a call or a message option. Activating one of the options may bring up further interfaces, as will be discussed in more detail below with regard to FIGS. 2A and 2B. For example, by interacting with the “Call” interactive element (using the “Call” option), the caller may be provided with a further interface which provides for more comprehensive interactions and possibilities to set up a group call.

FIGS. 2A and 2B show further graphical user interfaces provided to users on communication devices according to embodiments of the present disclosure. The graphical user interface 200 of FIG. 2A may be presented to a user, such as a caller, once an option has been selected in the graphical user interface 100, such as the “Call” option shown in FIG. 1. The graphical user interface 200 may display members of the called group, such as “User 1” to “User 5.” The user or caller may select the whole group or individual users. As indicated by blacked-out buttons 210, such as the buttons related to “User 1,” and “User 2,” the respective users may have accepted a call request. In addition, buttons 220, such as the buttons related to “User 3” and “User 4,” may indicate that the respective users have not accepted the call request yet. Furthermore, crossed button(s) 230, such as the button related to “User 5,” may indicate that the respective users declined the call request. Various actions may further be initiated by the user or caller via interactive elements 240. For example, actions could include one or more of starting a video call or a video conference call, sending a message, or leaving a calling card.

In addition, more comprehensive interactions between caller and recipients may be provided via interactive elements 240, for example, personalizing a call by adding additional information, like adding a calling card to the call. The calling card can be added to calls made to any number of recipients. Each recipient may receive from the caller a request to establish the group call, and additional information, such as a list of annotations, a priority level, an emergency call indication, a note, and other supplementary information with regard to said request, which may be presented to the recipient. This allows the caller to attach additional information to his or her request to establish a group call with a group of recipients. The client device of the recipient may receive the additional information entered by the caller and present the additional information to the respective recipient. Hence, the recipient may decide whether to participate in the group call or not. Furthermore, the additional information may be used to alter the processing of the receiving device, such as altering a ringing tone based on the additional information or displaying an indication of the caller's request on a display provided on the client device of the recipient. In addition, the request may be only presented to said recipient, when the additional information matches certain criteria, which may be freely set by the recipient.

As shown in FIG. 2B, a call request and additional information, if any, may be presented to a user receiving a group call on another graphical user interface 250. The graphical user interface 250 may be presented to a user (recipient) upon receiving a call or a call request. The graphical user interface 250 may display all members of the called group and a status, such as accepted, declined, or the like, which may be indicated by a blacked-out, a crossed, or otherwise configured button or box, similar to the buttons 210, 220, and 230 shown in FIG. 2A. Each recipient may have the option to accept or decline a call using interactive elements, such as buttons marked “ACCEPT” and “DECLINE” in FIG. 2B. Other group members that have accepted a call may be identified by a blacked-out button above a respective user icon or user description, such as the blacked-out buttons above users “User X,” “User 1,” and “User 2.” Furthermore, a decline of the group call may be identified by a crossed button above the user icon, such as the crossed button above “User 4.” During initiation of the call, all users in a group may see the status of the other group members in their respective user interfaces.

The status of the users shown in FIGS. 2A and 2B may be directly updated via the communication network of the group call system. As soon as a user changes his or her status, for example, by clicking on or touching the “ACCEPT” button shown in FIG. 2B, the status of the user may be signaled to the communication network, wherein a processing component dedicated to the group call may instantly provide updates to all corresponding user interfaces provided to other members of the group call.

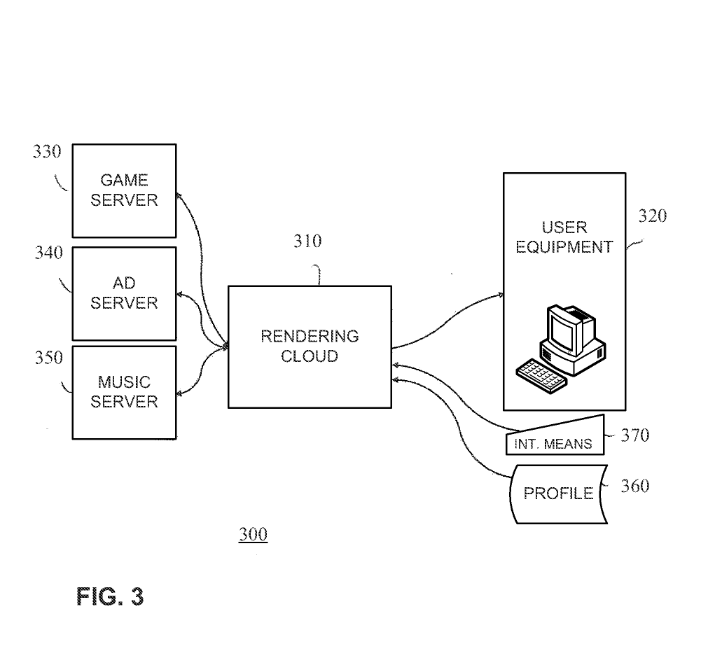

FIG. 3 depicts a structure of a network-based system according to one embodiment of the present disclosure. The system 300 may use a rendering cloud 310 to compute and render a data stream online, and to transfer the rendered data stream to one or more client devices 320, such communication devices or various user equipment. Since the data stream is rendered online, the resulting quality of the content can be chosen to meet a desired quality level. The rendering cloud 310 may be configured to provide a constant level of performance, for example, by using a plurality of distributed cloud servers.

The content of the data stream may include any kind of media or multimedia data, such as audio, 2D and 3D video, advertisements, still pictures, animations, and others. The content may also include interactive components, which may be responsive to user input. The rendering cloud 310 may receive the media data from several data sources, such as a game server 330, an advertisement server 340, a music server 350, or the like. Hence, the rendering cloud 310 may receive the media data, and include the media data into a combined data stream, which may include individual data streams (not shown) received from communication devices participating in a group call, and deliver the resulting enriched combined data stream to at least some communication devices, such as the user equipment 320.

The rendering of the combined data stream may be performed as follows: The rendering cloud 310 may retrieve content data from connected data sources 330, 340, 350, together with a stream build list that may define an order and composition of the single content data. Furthermore, the rendering cloud 310 may retrieve one or more data streams from communication devices. The rendering cloud 310 may combine the data streams as well as the content data into a single combined data stream. The combined data stream may further be compressed or encoded using a codec as specified by the stream build list. For example, the combined data stream may be encoded with a codec selected from a list of supported codecs on the client device 320. In addition, the supported codecs on the client device 320 may further be obtained by the rendering cloud 310 from a user's profile 360, which may either be stored on the client device 320 or within a personalized online space, such as within a social network or a cloud.

The user interacting with client device 320 may perceive the combined data stream and may react on the data stream using any suitable interaction means 370. For example, the user equipment 320 may include a touch screen and the user may use the touch screen to select an interactive element on a graphical user interface, such as the graphical user interfaces 200, 250 shown in FIGS. 2A and 2B, respectively.

As shown in FIG. 3, the rendering cloud 310 may provide multiple data streams from one or more data sources 330, 340, 350 and individual data streams from communication devices of users as a single combined data stream to at least one client device 320. For example, a user may open the combined data stream in a browser window, which may include the following active items: several video streams related to other users of the system 300, the output of a game played by the user, a playback of a music file, and an advertisement shown in an advertisement frame. All these components may be combined on the rendering cloud 310 and streamed as a single audio/video stream to client device 320 of the user.

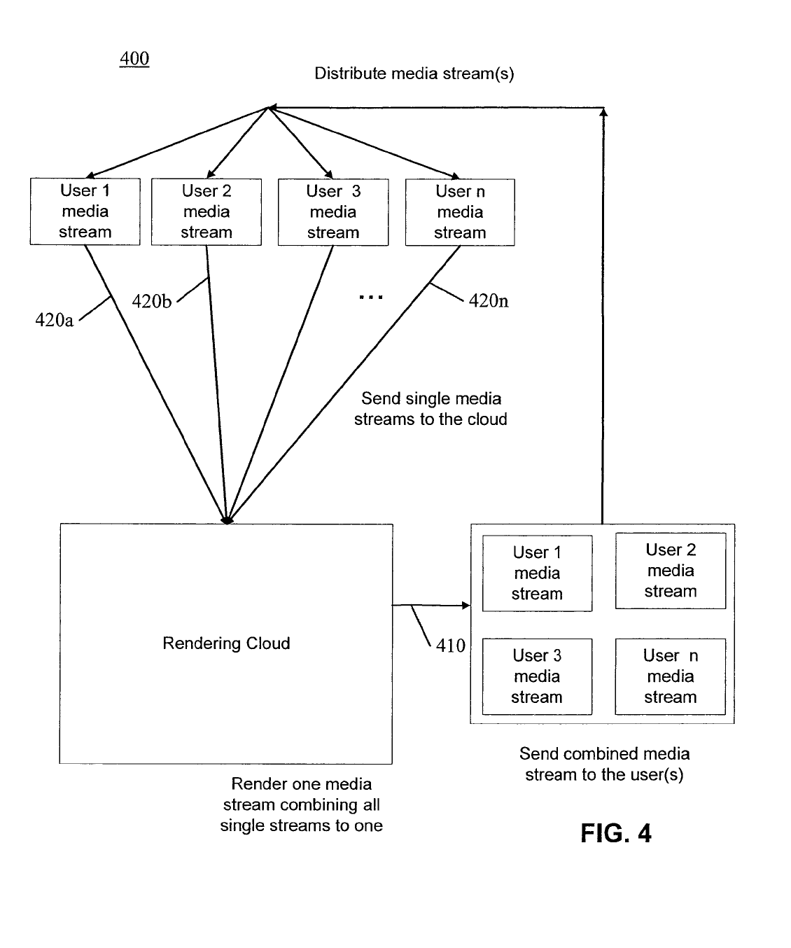

FIG. 4 illustrates functional and structural components of a communication system according to one embodiment of the present disclosure. A rendering cloud of the communication system 400 may provide a combined media stream 410 by combining individual media streams 420a, 420b, . . . , 420n generated by several communication devices.

The combined media stream 410 may be transmitted to one or more users of the communication system 400. For example, the combined media stream 410 may be transmitted to all users that provided media streams 420a, . . . , 420n to the rendering cloud. The users may participate in a group call and each communication device may include a camera and/or a microphone to record the user and his or her environment. The respective video stream, such as one of the media streams 420a, . . . , 420n, may be sent to the rendering cloud, where it may be combined with the other video streams and sent back to the respective communication devices as a combined video stream representing the group call.

As already discussed with regard to FIG. 3, the combined media stream 410 may also include content from other sources different from the media streams 420a, . . . , 420n. Furthermore, at least one user may also be enabled to change a view mode of the combined media stream 410. For example, the user may be watching an online video stream. The video stream may be displayed simultaneously in a frame next to the media streams 420a, . . . , 420n. The video stream or even several video streams and the individual media streams 420a, . . . , 420n may be streamed as one video stream, such as the combined media stream 410 from the rendering cloud. The user may switch to a different view enabling the respective video streams or media streams to be stacked behind each other, slightly overlapping, for example, by stacking the videos such that the videos are arranged at different depths in the stack. Any change of view mode may be animated, wherein an animation of moving from a first view mode, for example, videos arranged next to each other, to a second view mode, for example, a stacked view, may be calculated by the system 400 or the rendering cloud while the video and data streams keep running. Accordingly, the individual video and data streams may still be running in respective frames of the combined media stream 410, e.g., in the stacked view. Also, the view can be switched to a stereoscopic 3D view rendered on the rendering cloud.

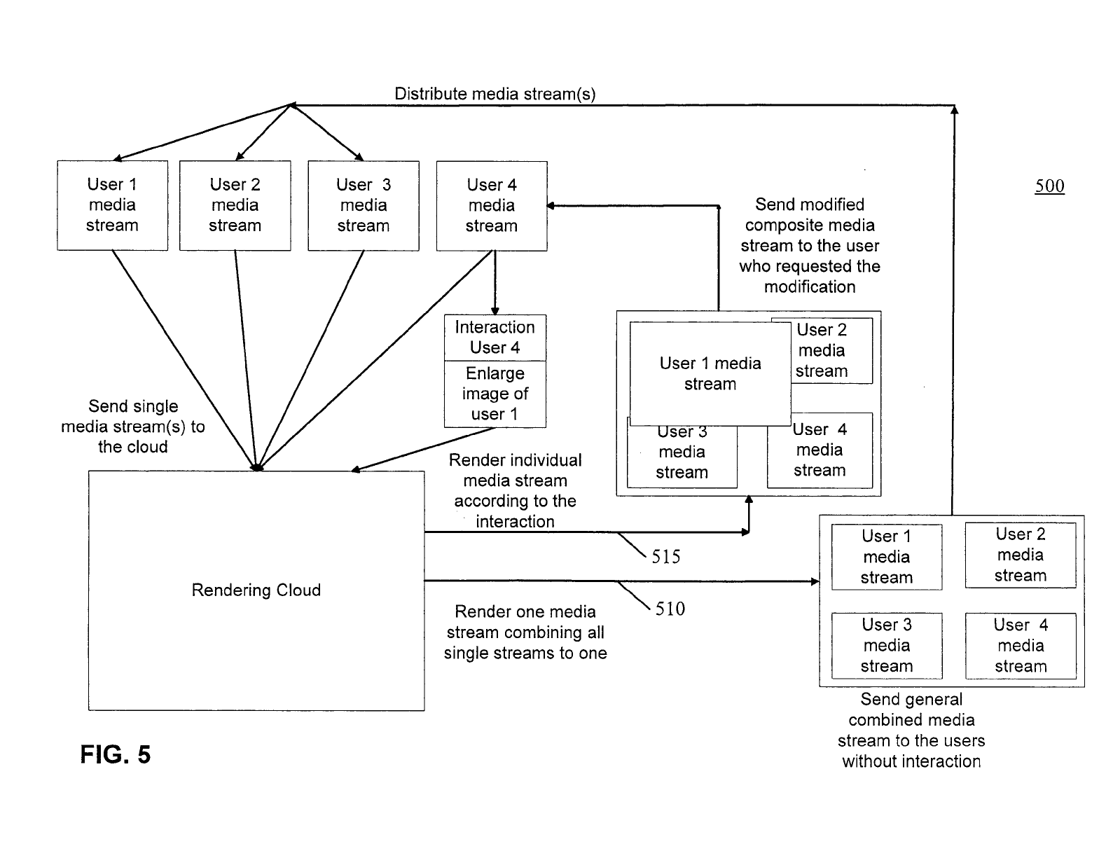

FIG. 5 illustrates functional and structural components of a communication system according to one embodiment of the present disclosure. The system 500 enables a customized rendering of combined data streams on a rendering cloud. The system 500 may be similar to the communication system 400 of FIG. 4, in that the rendering cloud receives a plurality of media streams from a plurality of communication devices operated by respective users, such as User 1 to User 4 shown in FIG. 5, and combines the media streams into a combined media stream 510, which may be provided back to the communication devices. In addition, the rendering cloud may further generate an individual media stream 515 for one or more of the communication devices, such as the communication device operated by User 4.

The system 500 may be used to introduce individual components into a combined video stream, including, for example, individual information, status information related to the communication device receiving the individual media stream 515, advertisements, or the like, including game advertisements. A user may play a game that supports in-game advertisements. Inside the game, ad-boards may be prominently placed. A texture may be projected inside the game on these ad-boards. The texture may be streamed from the server cloud to the game while the game is connected and running. The game may receive the stream as a texture that may be automatically placed inside the game on the appropriate object (e.g., a designated ad-board) without performance degradation and independent from the displayed content.

Both the system 400 shown in FIG. 4 and system 500 shown in FIG. 5 can be used to enable a group call or a video conference, including a plurality of users participating in the group call or video conference from different locations and using a plurality of communication devices including video cameras for their source video streams. Each user may be recorded by a separate video camera and may stream the resulting video stream to the rendering cloud. Inside the rendering cloud, all video streams may be combined into one combined video stream, such as the media streams 410 and 510, displaying (up to a certain amount) the video streams of every user as a tiled video frame, e.g., 16 single video streams are tiled as 4-by-4 smaller video streams into one combined video stream. The combined video stream may be provided to the users instead of the individual video streams, significantly reducing the required download bandwidth per user.

Each user may further interact with the combined video stream and request that a certain part of the combined video stream, for example, corresponding to one or more video streams of selected users, is to be enlarged inside the combined video stream. This request may be sent to the rendering cloud, which may generate an individual combined video stream, such as the media stream 515 shown in FIG. 5, and stream it to the requesting user. The system 500 may switch between the combined media stream 510 and the individual combined media stream 515 for each user at any time. In case more than one user requested the same configuration of the individual combined media stream 515, the system 500 may render the individual combined media stream 515 only once and provide the stream to two or more users. Accordingly, the individual combined media stream 515 can also be shared between two or more users. The interaction may include changes of the size of the components of the combined video stream. Furthermore, other manipulations of multimedia or video streams may be provided, such as color changes, contrast or brightness, and audio volume, to name a few.

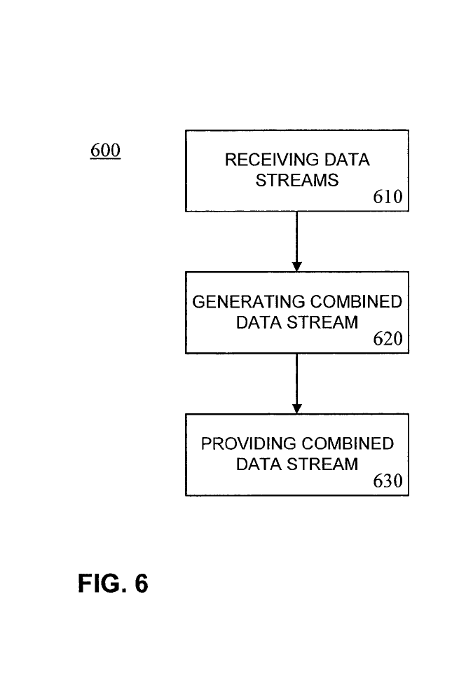

FIG. 6 shows a flow chart of a method for enabling group calls according to one embodiment of the present disclosure. The method 600 may be implemented on a processing component of a communication network or a rendering cloud in order to enable group calls. The method may start with step 610, wherein data streams from at least some of a plurality of communication devices may be received via a communication network. Thereafter, at step 620, a combined data stream may be generated from the data streams. The combined data stream may be provided to at least one of the plurality of communication devices at step 630, which may include one or more of the communication devices that provided the data streams received in step 610.

The data streams may include audio/video data to enable the group call. However, the data streams may also include additional media from other sources. In this way, a combined audio/video stream may be generated from any media content that may contain video, audio, still images, or graphics, to name a few. The processing component, such as a renderer in a rendering cloud, may be able to combine or mix different content sources into one stream and can do this individually for each single user or a group of users. Furthermore, the supplied combined video stream can be modified interactively by each user.

The group call system and method according to embodiments of the present invention is applicable in a plurality of exemplifying use cases, which are described in more detail below.

According to a use case related to calling and receiving of a call, a user may want to call everyone in his or her personal group, such as “Group 1” shown in FIG. 1. The user may trigger a “Contacts” button as shown in FIG. 1 in order to select a desired group and to identify at least one member or all members of the group. The user may, thereafter, select “Call,” “Message,” or “Manage” options as shown in FIG. 1 using the appropriate interactive elements. The “Manage” option may enable the user to administer the group or individuals within a group. A selection of one option may identify all members or at least some members of the group which are, thereafter, used as recipients of further actions. If the “Call” option is selected, another user interface may be presented to the caller showing further actions that may facilitate further interaction with potential recipients, such as the members of the group. The actions may in particular include features such as making a call, a video call, a video conference call, leaving a calling card, sharing devices, and enhancing the group call with additional information. Hence, the group call approach according to the present disclosure enables users to quickly set up a group call and advantageously communicate with other users in a group, such as friends within a social network.

In another use case related to video conference calls, users may join a video conference call from different locations, using various video cameras for their source videos. Every user may be recorded by his or her separate video camera and may stream his or her video stream onto the server cloud as, for example, discussed with regard to FIGS. 3 to 5 and other examples.

While some embodiments have been described in detail, it is to be understood that the aspect of the disclosure can take many forms. In particular, the claimed subject matter may be practiced or implemented differently from the examples described and the described features and characteristics may be practiced or implemented in any combination. The embodiments shown herein are intended to illustrate rather than to limit the invention as defined by the claims.

1. A communication system enabling group calls, comprising:
a communication network;
a plurality of communication devices connected to the communication network,
wherein each communication device is responsive to at least one user and includes means for providing a data stream; and
a processing component connected to the communication network, configured to receive the data streams from at least some of the plurality of communication devices via the communication network, and to generate from the data streams a combined data stream, wherein the processing component is further configured to provide the combined data stream to at least one of the plurality of communication devices.

2. The communication system according to claim 1, wherein the processing component is further configured to receive a request from at least one of the plurality of communication devices and to provide the combined data stream to the at least one communication device in response to the request.

3. The communication system according to claim 1, wherein at least some of the plurality of communication devices form a group of communication devices associated with a group call, and the processing component is configured to receive data streams from at least some of the group of communication devices, and to provide the combined data stream to at least one of the group of communication devices.

4. The communication system according to claim 3, wherein the processing component is further configured to provide to each communication device of the group a graphical user interface including one or more items representing at least some of the users of the communication devices of the group, wherein each item includes an indication of participation of the respective user in the group call.

5. The communication system according to claim 4, wherein each graphical user interface includes one or more interactive elements, which enable the respective user to control the group call.

6. The communication system according to claim 5, wherein the one or more interactive elements further enable the user to control participation of the user in the group call by accepting or declining a call request.

7. The communication system according to claim 5, wherein the one or more interactive elements further enable the user to control providing of the data stream from the communication device of the user to the processing component via the communication network, and/or to control receiving of the combined data stream from the processing component via the communication network.

8. The communication system according to claim 1, wherein the processing component generates the combined data stream according to at least one stream build list.

9. The communication system according to claim 1, wherein the processing component generates the combined data stream according to a predefined quality independently from any characteristics of the communication devices.

10. The communication system according to claim 9, wherein at least one of the communication devices interacts with the processing component to modify the combined data stream.

11. The communication system according to claim 10, wherein the processing component provides the modified combined data stream to other communication devices only if the other communication devices interact with the processing component to indicate the same choice of modification.

12. The communication system according to claim 1, wherein the processing component is further configured to provide to a user initiating the group call a personalized interface with further interactive elements which enable the user to set up the group call.

13. The communication system according to claim 1, wherein the data streams are video streams and the combined data stream is a combined video stream.

14. The communication system according to claim 1, wherein the communication network is one or more of a mobile network, a telephone network, and an IP-based network.

15. The communication system according to claim 1, wherein the processing component is implemented as a computing cloud, including a rendering cloud.

16. The communication system according to claim 15, wherein the computing cloud receives data streams from a plurality of data sources and generates from the data streams the combined data stream.

17. The communication system according to claim 1, wherein the communication network provides access to a social network, and at least some of the communication devices or at least some users are registered at the social network.

18. A communication device providing access to group calls, responsive to at least one user, comprising:
means for providing a data stream to a communication network; and
means for receiving a combined data stream to output the combined data stream to the at least one user,
wherein a processing component of the communication network receives the data stream and at least one further data stream from at least one further communication device via the communication network, and generates the combined data stream from the data stream and the at least one further data stream.

19. The communication device according to claim 18, further comprising means for recording the data stream, wherein the data stream is related to the at least one user.

20. The communication device according to claim 18, wherein the communication device and at least one further communication device form a group of communication devices associated with a group call, wherein the processing component is configured to receive data streams from at least some of the group of communication devices, and to provide the combined data stream to at least one of the group of communication devices.

21. The communication device according to claim 20, further comprising means for displaying a graphical user interface provided by the processing component, including one or more items representing at least some of the users of the communication devices of the group, wherein each item includes an indication of participation of the respective user in the group call.

22. The communication device according to claim 21, wherein the graphical user interface includes one or more interactive elements, enabling the at least one user to control the group call.

23. The communication device according to claim 18, wherein the communication device is one of a mobile device, a telephone device, a terminal device, a game console, and a computing device.

24. A method for enabling group calls, comprising:
receiving data streams from at least some of a plurality of communication devices via a communication network;
generating from the data streams a combined data stream; and
providing the combined data stream to at least one of the plurality of communication devices.

25. The method according to claim 24, further comprising receiving a request from at least one of the plurality of communication devices and providing the combined data stream to the at least one communication device in response to the request.

26. The method according to claim 24, wherein at least some of the plurality of communication devices form a group of communication devices associated with a group call, wherein said receiving includes receiving data streams from at least some of the group of communication devices, and wherein said providing includes providing the combined data stream to at least one of the group of communication devices.

27. The method according to claim 26, further comprising providing to each communication device of the group a graphical user interface including one or more items representing at least some of the users of the communication devices of the group, wherein each item includes an indication of participation of the respective user in the group call

28. The method according to claim 24, wherein said generating includes generating the combined data stream according to at least one stream build list.

29. A computer-readable medium having instructions stored thereon, wherein said instructions, in response to execution by a computing device, cause said computing device to automatically perform a method according to claim 24.
